(19) United States
(12) Patent Application Publication
(10) Pub. No.: US 2009/0207162 A1
(43) Pub. Date: Aug. 20, 2009

(54) PLASMA DISPLAY PANEL DRIVING METHOD AND PLASMA DISPLAY APPARATUS

(75) Inventors: Ryo Nakano, Yokohama (JP); Yoshinori Miyazaki, Yokohama (JP); Hiroki Ikeda, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/277,405

(22) Filed: Nov. 25, 2008

(30) Foreign Application Priority Data
Feb. 18, 2008 (JP) 2008-036381

(51) Int. Cl. G09G 5/00; G09G 3/28

(52) U.S. Cl. 345/214; 345/60

(57) ABSTRACT

A plasma display panel driving method and a plasma display apparatus are disclosed in which heat generation is reduced in a Y electrode driving circuit even when a display pattern on the plasma display panel becomes a horizontal band pattern. The plasma display panel driving method includes the steps of detecting an address switching load from input data by counting the number of switching times between ON and OFF of an address pulse applied to address electrodes, detecting a switching load among adjacent address data by counting the number of times in which ON and OFF of the address pulse are differently output among the adjacent address electrodes, and controlling to reduce the number of subfields by reducing a part of the subfields when the address switching load is a predetermined first threshold value or more and the switching load among address data is a predetermined second threshold value or less.

### BACKGROUND OF THE INVENTION

1. Field of the Invention

The present invention relates to a plasma display panel driving method and a plasma display apparatus.

2. Description of the Related Art

Conventionally, for example, Japanese Laid-Open Patent Publication No. H8-263007 (Patent Document 1) has disclosed a flat display panel apparatus. In the flat display panel apparatus, even if an address current is changed due to a large change of display data such as a motion picture, in order to enable stably controlling an address frequency, one frame is formed of plural subfields, and a gradation display having two steps or more or a multicolor display is formed by combining some of the plural subfields. The flat display panel apparatus provides a current detecting unit which detects an address current value to be consumed in each frame, a comparing unit which compares the address current value detected by the current detecting unit with at least two reference current values, and an address frequency control unit which controls the address frequency in a display frame based on an output from the comparing unit.

With this, in a case where the address frequency is controlled when the address current is increased, even if a current value is changed due to a change of display data, an uncomfortable feeling caused by a change of display characteristics on a screen can be reduced by the frequency control.

When the display characteristics are changed due to a change of the address current, the change of the display characteristics can be controlled in the structure of Patent Document 1; however, a change of the display characteristics due to another reason cannot be prevented.

In a plasma display apparatus using a plasma display panel, in the address period in which a cell to be lighted is selected, in addition to the change of the display characteristics, in some cases, heat is generated in a driving circuit. In Patent Document 1, a circuit which generates heat caused by the address current can be protected; however, a circuit cannot be protected from heat being generated due to another reason.

For example, in a case where a display pattern called a transverse band pattern (horizontal band pattern) in which black row patterns and white row patterns are alternately displayed in the vertical direction on a plasma display panel, when a Y electrode scans in the address period and an address pulse is applied by being switched, a current for charging and discharging flows between a Y electrode driving circuit and an address driving circuit, and elements on the circuits generate heat. That is, in the horizontal band pattern, the amount of the charging and discharging current between address electrodes of discharge cells disposed adjacent to each other in the horizontal direction becomes small and the number of switching times of the address pulse is great, and the current between the Y electrode driving circuit and the address driving circuit becomes a maximum value.

FIG. 9 is a diagram showing the horizontal band pattern displayed on a plasma display panel 10. In FIG. 9, a stripe pattern is formed on the plasma display panel 10 so that black lines and white lines extending in the horizontal direction are alternately formed in the vertical direction. In such an image pattern of the horizontal band pattern, a phenomenon is detected in which heat generated in the Y electrode driving circuit becomes a maximum value. In a case where a horizontal band pattern repeating cycle which generates heat is studied, in the sequential scanning of each line, as shown in FIG. 9, when an image is displayed in which the black lines and the white lines are alternately displayed, the heat generated in the Y electrode driving circuit becomes the maximum. In addition, in interlaced scanning in which lines are scanned every two lines or every plural lines, heat generated in the Y electrode driving circuit becomes the maximum in a display image at the horizontal band repeating cycle corresponding to the interlaced scanning.

FIG. 10 is a diagram showing an address discharge when a horizontal band pattern is displayed on the plasma display panel 10. In FIG. 10, address electrodes Aⱼ and Y electrodes Yᵢ of the plasma display panel 10 are shown, and X electrodes (described below) are omitted.

In FIG. 10, a part of address electrodes Aⱼ and a part of Y electrodes Yᵢ of the plasma display panel 10 are shown.

In FIG. 10, the address electrodes A₁ through A₆ extending in the vertical direction and the Y electrodes Y₁ through Y₆ extending in the horizontal direction are shown, and a discharge cell is formed at a position where the address electrode Aⱼ crosses the Y electrode Yᵢ. In addition, in FIG. 10, a pulse applied to the Y electrode Yᵢ and another pulse applied to the address electrode Aⱼ are also shown at the corresponding positions. In the address discharge, a positive address pulse Va is applied to an address electrode Aⱼ of a discharge cell to be lighted and a negative scan pulse −Vy is sequentially applied to the Y electrodes Y₁ through Y₆. With this, an address discharge is generated in a discharge cell where a potential difference between an address electrode Aⱼ and a Y electrode Yᵢ becomes Va−(−Vy)=Va+Vy (see “o” in FIG. 10) and an address discharge is not generated in another discharge cell where the potential difference between the address electrode Aⱼ and the Y electrode Yᵢ does not become Va−(−Vy)=Va+Vy (see “x” in FIG. 10). That is, when the address discharge is generated in the discharge cell, the discharge cell to be lighted is selected.

In FIG. 10, in the Y electrode Y₁, the positive address pulse Va is applied to the address electrodes A₁ through A₆ and the negative scan pulse −Vy is applied to the Y electrode Y₁; therefore, the address discharge is generated in all discharge cells in the line of the Y electrode Y₁. In the Y electrode Y₂, the negative scan pulse −Vy is applied to the Y electrode Y₂, but the positive address pulse Va is not applied to the address electrodes A₁ through A₆ and the address electrodes A₁ through A₆ are at zero potential; therefore, the address discharge is not generated in all discharge cells in the line of the Y electrode Y₂.

When the above operations are repeated in which the positive address pulse Va is sequentially applied to the address electrodes A₁ through A₆, and the negative scan pulse −Vy is applied to the Y electrode Yᵢ, a discharge cell to be lighted can be selected in a screen of the plasma display panel 10.

As shown in FIG. 10, in the horizontal band pattern, when columns of the address electrodes A₁ through A₆ in the vertical direction are focused on, discharge cells to be lighted and discharge cells to be unlighted are alternately disposed, and when rows of the Y electrodes Y₁ through Y₆ in the horizontal direction are focused on, all discharge cells are to be lighted in a line or to be unlighted in another line. In the above horizontal band pattern, it is well known that the heat generated in the Y electrode driving circuit becomes the maximum.

Next, referring to FIG. 11, a reason why the heat generated in the Y electrode driving circuit becomes the maximum in the horizontal band pattern shown in FIGS. 9 and 10 is described. FIG. 11 is a circuit diagram of an address electrode driving circuit 20, an X electrode driving circuit 30, and a Y electrode driving circuit 40 for driving the plasma display panel 10. In FIG. 11, a circuit diagram of the plasma display panel 10 is also shown.

In a discharge cell Cᵢⱼ of the plasma display panel 10, a capacitive load is formed between an X electrode Xᵢ and a Y electrode Yᵢ, a capacitive load Cₐₓ is formed between an address electrode Aⱼ and the X electrode Xᵢ, and a capacitive load C_{ay} is formed between the address electrode Aⱼ and the Y electrode Yᵢ. Since a problem of the address discharge in the address period is studied, a relationship between the Y electrode driving circuit 40 and the address electrode driving circuit 20 is studied.

In FIG. 11, when a horizontal band pattern is formed on the plasma display panel 10 by an address selection, as shown in FIG. 10, the address electrode driving circuit 20 forms a switching pattern in which the positive address pulses Va and ground potential (0 V) are alternately applied to the address electrodes Aⱼ with the passage of time. That is, in the switching pattern, switching elements Ma1 and Ma2 in the address electrode driving circuit 20 are alternately switched between ON and OFF; when the switching element Ma1 is ON and the switching element Ma2 is OFF, the positive address pulse Va is output, and when the switching element Ma1 is OFF and the switching element Ma2 is ON, ground potential (0 V) is output.

The Y electrode driving circuit 40 includes a scan driver 41 and a sustain driver 42; the scan driver 41 provides switching elements My1 and My2, and the sustain driver 42 provides switching elements My3 and My4. In the scan driver 41, when a scan pulse is sustained to be ground potential, the switching element My1 is switched ON and the switching element My2 is switched OFF, and when the negative scan pulse −Vy is applied to a Y electrode Yᵢ, the switching element My1 is switched OFF and the switching element My2 is switched ON.

In the address period, the switching elements Ma1 and Ma2 in the address electrode driving circuit 20 alternately repeat ON and OFF, and electric potential to be applied to the capacitive load C_{ay} is alternately fixed to ground potential and the positive address pulse Va.

When the scan driver 41 of the Y electrode driving circuit 40 scans the Y electrode Yᵢ, the scan driver 41 outputs the negative scan pulse −Vy, and when the scan driver 41 does not scan the Y electrode Yᵢ, the scan driver 41 outputs ground potential (0 V). In the capacitive load C_{ay}, an electric charge Q=C_{ay}×V is created by a voltage V between both ends of the capacitive load C_{ay}; however, since the capacitance of the capacitive load C_{ay} is constant, the electric charge Q is changed by the change of the voltage V. The changed electric charge Q generates a current and the current flows into a resistor R in the Y electrode driving circuit 40. When the amount of the current is great, heat is generated in the resistor R; consequently, heat is generated in the Y electrode driving circuit 40.

When electric potential output from the address electrode driving circuit 20 is frequently changed due to the switching in the address electrode driving circuit 20 and the amount of the electric charge Q to be stored in the capacitive load C_{ay} is great, the current flowing into the resistor R becomes great. Therefore, when all the lines in the horizontal direction have the same electric potential, it is conceivable that the Y electrode Yi having the greatest electric charge is generated and the current flowing into the resistor R becomes the maximum value. Consequently, when the horizontal band pattern shown in FIGS. 9 and 10 is formed, the amount of heat generated in the Y electrode driving circuit 40 becomes the maximum value.

In the sustain driver 42, by switching ON the switching element My3 and switching OFF the switching element My4, the sustain driver 42 generates a sustain pulse Vs (described below) and applies the sustain pulse Vs to the discharge cell Cᵢⱼ; and by switching OFF the switching element My3 and switching ON the switching element My4, the sustain driver 42 applies ground potential to the discharge cell Cᵢⱼ.

Similar to the sustain driver 42, in the X electrode driving circuit 30, by switching ON a switching element Mx1 and switching OFF a switching element Mx2, the X electrode driving circuit 30 generates the sustain pulse Vs and applies the sustain pulse Vs to the discharge cell Cᵢⱼ; and by switching OFF the switching element Mx1 and switching ON the switching element Mx2, the X electrode driving circuit 30 applies ground potential to the discharge cell Cᵢⱼ. That is, the sustain pulse Vs is alternately applied to the X electrode Xᵢ and the Y electrode Yᵢ, and a sustain discharge can be performed. When the sustain discharge is performed, even if the display pattern is the horizontal band pattern, the problem of heat being generated in the Y electrode driving circuit 40 does not occur.

However, as described above, when the display pattern is the horizontal band pattern, heat is generated in the Y electrode driving circuit 40 in the address period.

### SUMMARY OF THE INVENTION

In a preferred embodiment of the present invention, there is provided a plasma display panel driving method and a plasma display apparatus in which heat generation in a Y electrode driving circuit is reduced in an address period even if a display pattern on the plasma display panel is a horizontal band pattern or a pattern approximating the horizontal band pattern.

According to one aspect of the present invention, there is provided a plasma display panel driving method for driving a plasma display panel by dividing one field of an image into plural subfields. The plasma display panel includes plural address electrodes extending in the vertical direction, plural Y electrodes extending in the horizontal direction, and plural discharge cells formed at corresponding positions where each address electrode crosses each Y electrode in the planar view. The plasma display panel driving method includes the steps of detecting an address switching load from input data by counting the number of switching times between ON and OFF of an address pulse applied to the address electrodes, detecting a switching load among adjacent address data by counting the number of times in which ON and OFF of the address pulse are differently output among the adjacent address electrodes, and controlling to reduce the number of subfields by reducing a part of the subfields when the address switching load is a predetermined first threshold value or more and the switching load among address data is a predetermined second threshold value or less.

With this, when a horizontal band pattern or a pattern approximating the horizontal band pattern is displayed on the plasma display panel in which pattern an address pulse applied to address electrodes alternately becomes ON and OFF in the vertical direction and the address pulse applied to the adjacent address electrodes in the horizontal direction continues to be ON or OFF, a current flowing into a Y electrode driving circuit can be reduced by detecting the display pattern. Therefore, heat generation in the Y electrode driving circuit can be reduced.

### BRIEF DESCRIPTION OF THE DRAWINGS

Features and advantages of the invention will become more apparent from the following detailed description when read in conjunction with the accompanying drawings, in which:

FIG. 1 is a structural diagram showing a plasma display apparatus according to an embodiment of the present invention;

FIG. 2 is a perspective view of the plasma display panel shown in FIG. 1;

FIG. 3 is a diagram showing a zigzag display pattern;

FIG. 4 is a diagram showing a relationship between one field of an image and subfields;

FIG. 5 is a diagram showing waveforms of voltages to be applied to corresponding electrodes in a plasma display panel driving method and the plasma display apparatus according to the embodiment of the present invention;

FIG. 6 is a block diagram showing the plasma display apparatus according to the embodiment of the present invention;

FIG. 7 is a diagram showing control of reducing the number of subfields by the number of subfield reducing control unit shown in FIG. 1;

FIG. 8 is a block diagram showing the plasma display apparatus having a load ratio calculating unit according to the embodiment of the present invention;

FIG. 9 is a diagram showing a horizontal band pattern displayed on the plasma display panel;

FIG. 10 is a diagram showing an address discharge when the horizontal band pattern is displayed on the plasma display panel; and

FIG. 11 is a circuit diagram of driving circuits for driving the plasma display panel.

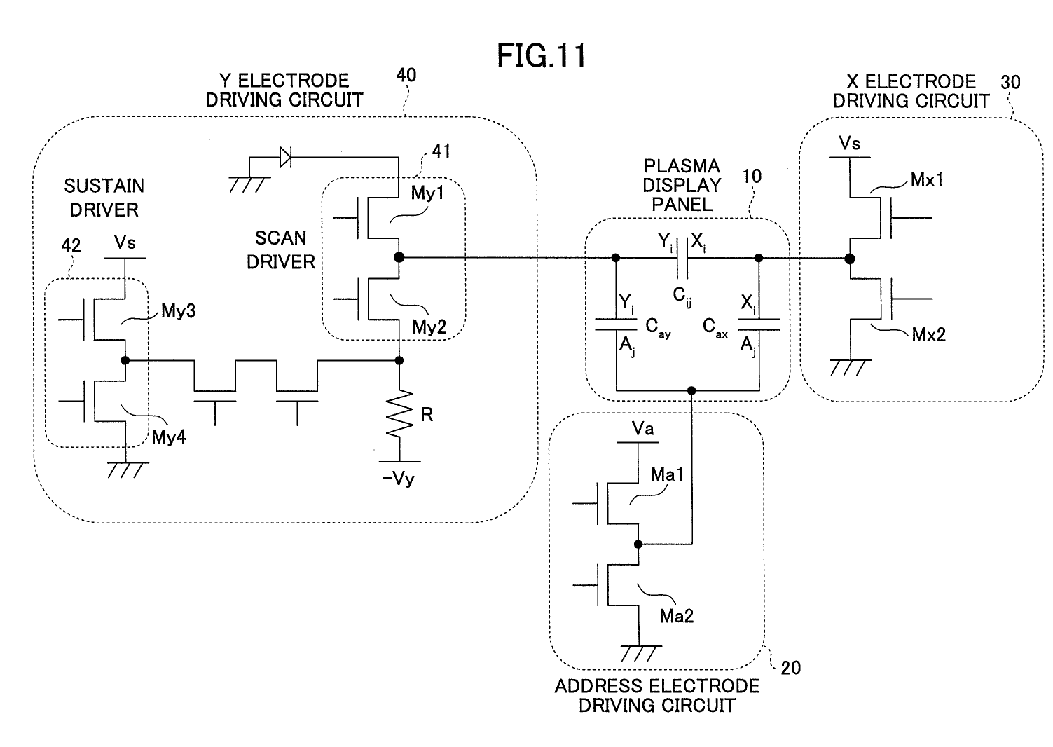

### DETAILED DESCRIPTION OF THE PREFERRED EMBODIMENT

In the following, a preferred embodiment of the present invention is described with reference to the drawings.

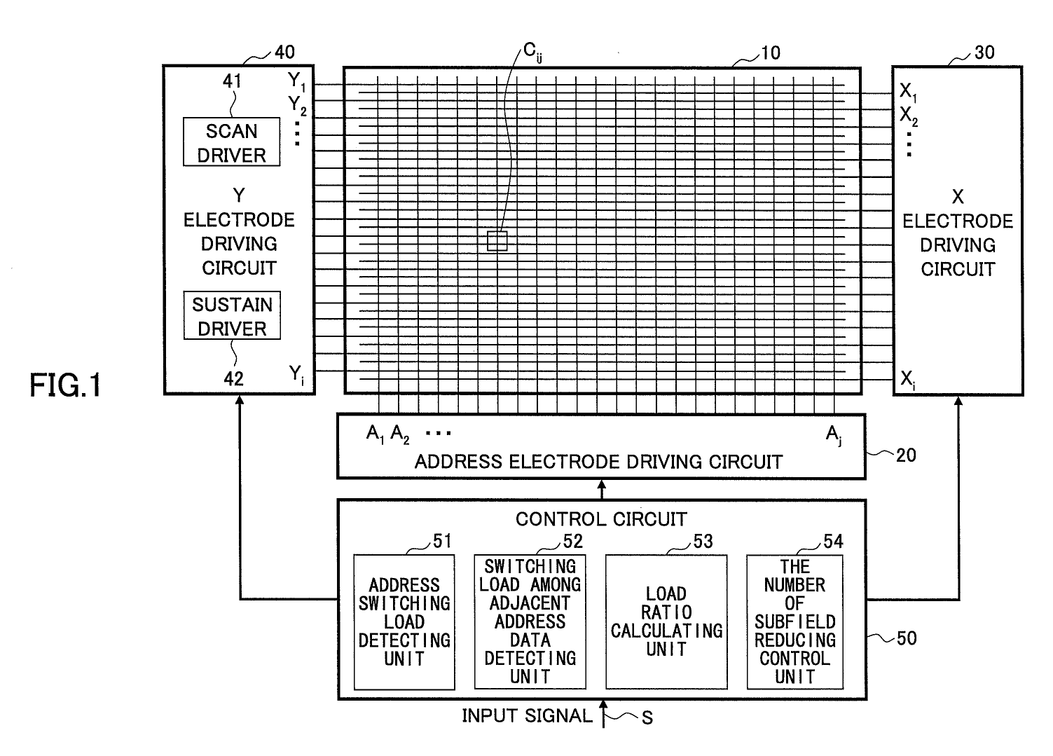

FIG. 1 is a structural diagram showing a plasma display apparatus according to the embodiment of the present invention. As shown in FIG. 1, the plasma display apparatus according to the embodiment of the present invention includes a plasma display panel 10, an address electrode driving circuit 20, an X electrode driving circuit 30, a Y electrode driving circuit 40, and a control circuit 50.

An image is displayed on the plasma display panel 10. The plasma display panel 10 includes plural X electrodes X₁, X₂, X₃, . . . , Xᵢ extending in the horizontal direction (lateral direction), and plural Y electrodes Y₁, Y₂, Y₃, . . . , Yᵢ extending in the horizontal direction. In the following, in some cases, the electrode(s) Yᵢ having a suffix “i” represents each Y electrode or the plural Y electrodes, and the electrode(s) Xᵢ having a suffix “i” represents each X electrode or the plural X electrodes. In addition, the plasma display panel 10 includes plural address electrodes A₁, A₂, A₃, . . . , Aⱼ extending in the vertical direction (longitudinal direction). In the following, in some cases, the address electrode(s) Aⱼ having a suffix “j” represents each address electrode or the plural address electrodes.

The X electrodes Xᵢ and the Y electrodes Yᵢ extending in the horizontal direction are alternately disposed in the vertical direction. The X electrode Xᵢ can be called a sustain electrode, and the Y electrode Yᵢ can be called a scan electrode. At a position where the X electrode Xᵢ, the Y electrode Yᵢ, and the address electrode Aⱼ cross each other in the planar view, a discharge cell Cᵢⱼ (display cell) is formed. The discharge cell Cᵢⱼ corresponds to a pixel, and the plasma display panel 10 can display a two-dimensional image by utilizing the discharge cells Cᵢⱼ. In the discharge cell Cᵢⱼ, a space exists between the X electrode Xᵢ and the Y electrode Yᵢ and the space forms a capacitive load.

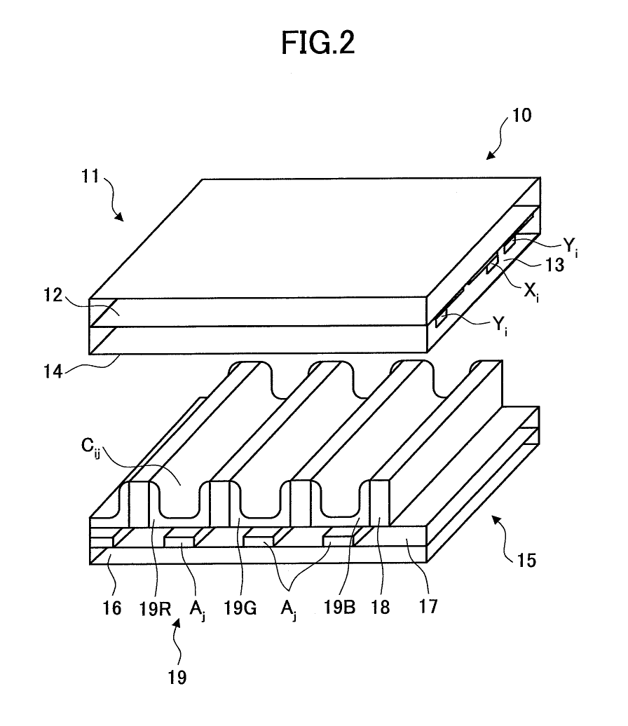

FIG. 2 is a perspective view of the plasma display panel 10. As shown in FIG. 2, the plasma display panel 10 includes an upper substrate 11 and a lower substrate 15. The plasma display panel 10 is formed so that the upper substrate 11 and the lower substrate 15 are adhered facing each other.

The upper substrate 11 includes a glass substrate 12 and the plural X electrodes Xᵢ and the plural Y electrodes Yᵢ are extended in the horizontal direction (lateral direction) on the inner surface of the glass substrate 12 so that the X electrodes Xᵢ and the Y electrodes Yᵢ are alternately disposed in the vertical direction (longitudinal direction). In addition, the upper substrate 11 includes a dielectric layer 13 and a protection film 14, and the dielectric layer 13 and the protection film 14 cover the X electrodes Xᵢ and the Y electrodes Yᵢ.

The lower substrate 15 includes a glass substrate 16, and the plural address electrodes Aⱼ are extended in the vertical direction (longitudinal direction) on the surface of the glass substrate 16, and a dielectric layer 17 covers the plural address electrodes Aⱼ and the glass substrate 16. In addition, plural ribs 18 are formed on the dielectric layer 17.

Plural partitions are formed at the position where the upper substrate 11 faces the lower substrate 15 by the plural ribs 18, and the plural discharge cells Cᵢⱼ are formed by the partitions. That is, a region divided by the partitions at the position where the X electrode Xᵢ and the Y electrode Yᵢ cross the address electrode Aⱼ forms the discharge cell Cᵢⱼ. In addition, on the surface of the discharge cell Cᵢⱼ; that is, between the two adjacent ribs 18, a fluorescent substance 19 is formed. The fluorescent substance 19 includes a red fluorescent substance 19R, a green fluorescent substance 19G, and a blue fluorescent substance 19B, and a pixel is formed by the above three fluorescent substances 19R, 19G, and 19B.

In a discharge of the discharge cell Cᵢⱼ, when pluses are applied to the corresponding address electrode Aⱼ and the Y electrode Yᵢ, an address discharge is generated, and a wall electric charge is stored in the discharge cell Cᵢⱼ by the address discharge. In the address discharge, an ON signal of the address pulse is applied to a discharge cell Cᵢⱼ to be lighted, and an OFF signal of the address pulse is applied to another discharge cell Cᵢⱼ to be unlighted. The address pulses corresponding to whether the discharge cells Cᵢⱼ are to be lighted or unlighted are simultaneously applied to all the address electrodes A₁ through Aⱼ.

In a line of the Y electrodes Yᵢ where an address selection is performed, a scan pulse is sequentially applied to the Y electrodes Y, through Yᵢ. Corresponding to the ON or OFF signal of the address electrodes Aⱼ, the address discharge is generated in a discharge cell Cᵢⱼ to which the ON signal is applied and the address discharge is not generated in another discharge cell Cᵢⱼ to which the OFF signal is applied. A period in which an address discharge is generated and a discharge cell Cᵢⱼ to be lighted is selected is called the address period.

Next, sustain pulses are applied to the corresponding X electrode Xᵢ and Y electrode Yᵢ; since a sufficient wall electric charge is stored in a discharge cell Cᵢⱼ where the address discharge is generated, a sustain discharge is generated in the discharge cell Cᵢⱼ and the discharge cell Cᵢⱼ is lighted, and another discharge cell Cᵢⱼ where the address discharge is not generated is not lighted due to no sustain discharge. A period during which the sustain discharge is generated is called a sustain period.

The plasma display apparatus of the present invention can include the plasma display panel 10 shown in FIG. 2. The plasma display panel driving method according to the present embodiment can be applied to another plasma display panel in which the address discharge is performed.

Returning to FIG. 1, some structural elements in the plasma display apparatus are described in detail.

The address electrode driving circuit 20 drives the address electrodes Aⱼ. The address electrode driving circuit 20 supplies an address pulse having a predetermined voltage to the address electrode Aⱼ and generates an address discharge in the discharge cell Cᵢⱼ.

The Y electrode driving circuit 40 drives the Y electrode Yᵢ and includes a scan driver 41 and a sustain driver 42.

The scan driver 41 supplies a scan pulse having a predetermined voltage to the Y electrode Yᵢ and generates an address discharge in a discharge cell Cᵢⱼ corresponding to control of the control circuit 50 and the sustain driver 42.

The sustain driver 42 supplies a sustain pulse having a predetermined voltage to the Y electrode Yᵢ and generates a sustain discharge in a discharge cell Cᵢⱼ.

The X electrode driving circuit 30 drives the X electrodes Xᵢ. The X electrode driving circuit 30 supplies a sustain pulse having a predetermined voltage to the X electrodes Xᵢ and generates a sustain discharge in discharge cells Cᵢⱼ. The X electrodes Xᵢ are connected to each other and have the same voltage level.

The control circuit 50 controls and drives the address electrode driving circuit 20, the X electrode driving circuit 30, and the Y electrode driving circuit 40. When an input signal S of one frame or one field of an image which is a general image signal is input to the control circuit 50, the control circuit 50 performs subfield conversion in which the image of one frame or one field is divided into plural subfields, and generates address data for driving the address electrode driving circuit 20 and generates scan data for driving the scan driver 41 of the Y electrode driving circuit 40. In addition, the control circuit 50 generates sustain data for driving the X electrode driving circuit 30 and the sustain driver 42 of the Y electrode driving circuit 40.

In order to reduce the heat generation in the Y electrode driving circuit 40 when a display image on the plasma display panel 10 becomes a horizontal band pattern or a pattern approximating the horizontal band pattern, the control circuit 50 according to the present embodiment includes an address switching load detecting unit 51, a switching load among adjacent address data detecting unit 52, a load ratio calculating unit 53, and the number of subfield reducing control unit 54.

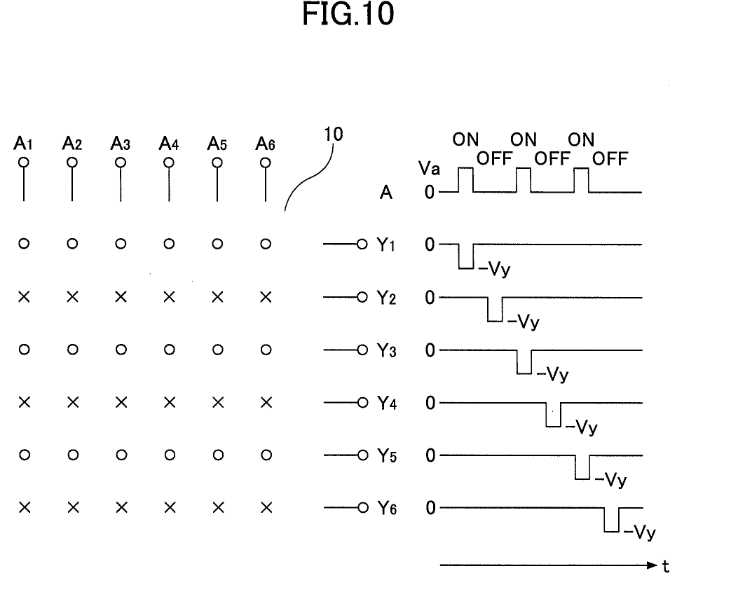

The address switching load detecting unit 51 counts the number of switchings between ON and OFF of the address pulse when the control circuit 50 generates the address data to be sent to the address electrode driving circuit 20 from the input data of the input signal S. As shown in FIG. 10, when a horizontal band pattern is displayed, an address pulse which switches between ON and OFF every one line is applied to the address electrode Aⱼ; therefore, the address switching load detecting unit 51 counts the number of switchings between ON and OFF of the address pulses in the vertical direction, and detects whether the input data satisfy the conditions of the horizontal band pattern.

Since the address pulse is output by synchronizing with scanning of the Y electrode Yᵢ in each address electrode Aⱼ, it is possible that the address switching load detecting unit 51 counts the number of switchings between ON and OFF of the address pulse of all the address electrodes Aⱼ and sums the counted numbers. That is, the address switching load detecting unit 51 detects an address switching load by synchronizing with the scanning of the Y electrode Yᵢ. In normal control, it is sufficient that the address switching load is detected in one screen of an image, one subfield of the image, or one field of the image; however, since the output number of the address pulses corresponds to the scanning line number of the Y electrodes Yᵢ, the above control can be applied in the middle of the one screen of the image.

The address switching load detecting unit 51 can be realized by a predetermined electronic circuit, for example, an ASIC (application specific integrated circuit) or an MPU (micro processing unit). Detailed operations of the address switching load detecting unit 51 are described below.

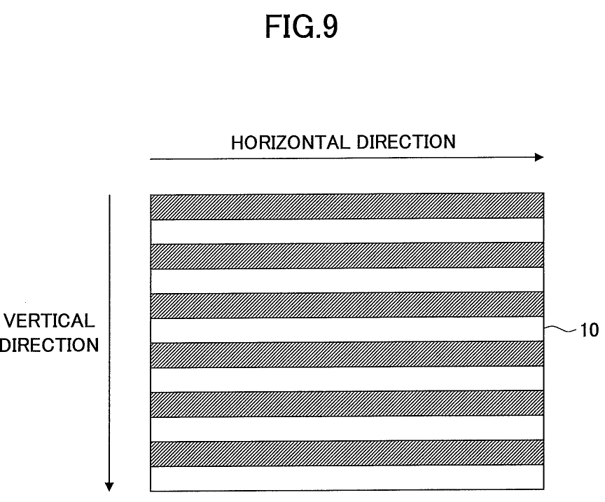

The switching load among adjacent address data detecting unit 52 counts and detects the number of times in which ON and OFF of the address pulse are differently output among the adjacent address electrodes Aⱼ₋₁, Aⱼ, and Aⱼ₊₁. As shown in FIGS. 9 and 10, when a horizontal band pattern is displayed, one line in the horizontal direction is lighted and another line in the horizontal direction is unlighted. The switching load among adjacent address data detecting unit 52 focuses on the lighted or unlighted pattern in the horizontal lines and detects the number of times when ON and OFF are adjacently output in the adjacent address pulses and detects whether a display pattern is the horizontal band pattern or a pattern approximating the horizontal band pattern.

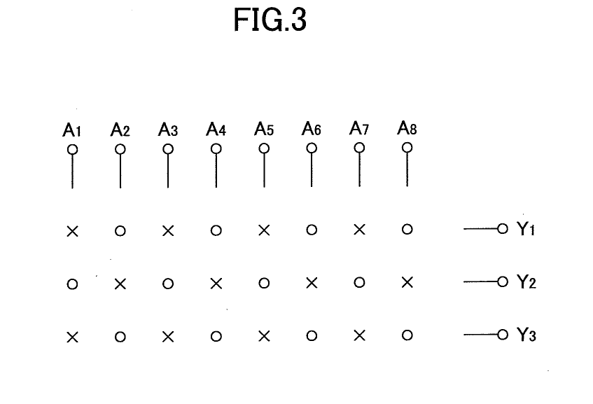

FIG. 3 is a diagram showing a zigzag display pattern. In FIG. 3, lighted cells and unlighted cells are alternately displayed in lines of the Y electrodes Y₁, Y₂, and Y₃. In the display pattern shown in FIG. 3, when ON and OFF of the address electrodes A₁ through A₈ are focused on, ON and OFF are switched in every one line of the address electrodes A₁ through A₈, and by only the address switching load detecting unit 51, the difference between the zigzag display pattern and the horizontal band pattern cannot be detected. However, the switching load among adjacent address data detecting unit 52 can accurately detect the difference between the zigzag display pattern and the horizontal band pattern.

In the detection by the switching load among adjacent address data detecting unit 52, when the number of times when ON and OFF of the address pulses are adjacently output among the adjacent address electrodes Aⱼ in the horizontal direction is small; that is, ON or OFF is almost continued, the load and the heat generated in the Y electrode driving circuit 40 becomes great. Similar to the address switching load detecting unit 51, the switching load among adjacent address data detecting unit 52 can be realized by a predetermined electronic circuit, for example, an ASIC or an MPU. Detailed operations of the switching load among adjacent address data detecting unit 52 are described below.

Returning again to FIG. 1, some structural elements in the plasma display apparatus are described in detail.

The number of subfield reducing control unit 54 controls reducing the number of subfields based on the results detected by the address switching load detecting unit 51 and the switching load among adjacent address data detecting unit 52. That is, when the number of subfield reducing control unit 54 determines that an image is a horizontal band pattern or a pattern approximating the horizontal band pattern and heat is generated in the Y electrode driving circuit 40, the number of subfield reducing control unit 54 controls reducing the number of subfields, reduces a current flowing into the Y electrode driving circuit 40, and reduces the heat generation in the Y electrode driving circuit 40. In other words, when the number of subfields is reduced, a current flowing into the Y electrode driving circuit 40 is reduced, the load for the Y electrode driving circuit 40 is lowered, and the heat generation can be reduced in the Y electrode driving circuit 40.

Similar to the address switching load detecting unit 51, the number of subfield reducing control unit 54 can be realized by a predetermined electronic circuit, for example, an ASIC or an MPU. Determination of the horizontal band pattern and detailed operations of the number of subfield reducing control unit 54 are described below.

The load ratio calculating unit 53 calculates a ratio of the address switching load (the number of switching times between ON and OFF) detected by the address switching load detecting unit 51 to the switching load among adjacent address data (the number of adjacent times of ON and OFF signals) detected by the switching load among adjacent address data detecting unit 52. The load ratio calculating unit 53 can be included in the control circuit 50 depending on necessity.

As described above, when the address switching load is great, the load in the Y electrode driving circuit 40 is great, and when the switching load among adjacent address data is small, the load in the Y electrode driving circuit 40 is great. Therefore, for example, a ratio is obtained by dividing the switching load among adjacent address data by the address switching load, and when the obtained ratio is a predetermined load ratio threshold value or less, it can be determined that a pattern is a horizontal band pattern or a pattern approximating the horizontal band pattern.

In FIG. 1, the address switching load detecting unit 51, the switching load among adjacent address data detecting unit 52, the load ratio calculating unit 53, and the number of subfield reducing control unit 54 are disposed in the control circuit 50. However, the address switching load detecting unit 51, the switching load among adjacent address data detecting unit 52, the load ratio calculating unit 53, and the number of subfield reducing control unit 54 can be independently disposed in the plasma display apparatus or can be disposed in the address electrode driving circuit 20, the X electrode driving circuit 30, or the Y electrode driving circuit 40.

Next, a general subfield method which is used in the control circuit 50 is described.

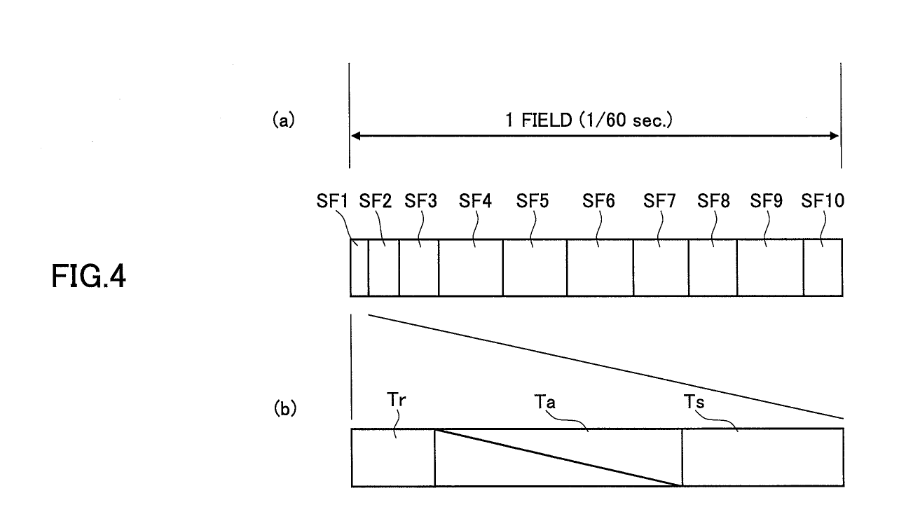

FIG. 4 is a diagram showing a relationship between one field of an image and subfields SFs. In FIG. 4(a), one field of the image is divided into the plural subfields SFs, and as an example, the number of the subfields SFs is 10. That is, the subfields SF1 through SF10 are shown in FIG. 4. In the plasma display panel driving method and the plasma display apparatus according to the embodiment of the present invention, one field of an image is divided into plural subfields SFs and the plasma display panel 10 is driven by using a subfield method by which gradations of the image are displayed. In the plasma display panel 10, the gradations of the image are displayed by the second power of the number of discharge times; therefore, the subfield method is used. In FIG. 4(a), one field of an image is received at 1/60 second, the one field of the image is divided into the 10 subfields, and the gradations of the image are displayed. In FIG. 4, the 10 subfields SFs are shown; however, the number of the subfields SFs can be, for example, 8 depending on application.

Discharge periods of one subfield are shown in FIG. 4(b). In FIG. 4(b), the one subfield SF1 is divided into three discharge periods; that is, a reset period Tr, an address period Ta, and a sustain period Ts. In the reset period Tr, the wall electric charge of the discharge cell Cᵢⱼ is initialized by a reset discharge; in the address period Ta, a discharge cell Cᵢⱼ to be lighted is selected by an address discharge; and in the sustain period Ts, the selected discharge cell Cᵢⱼ is lighted by a sustain discharge. In the plasma display panel driving method and the plasma display apparatus according to the embodiment of the present invention, the heat generation in the Y electrode driving circuit 40 is reduced when the address discharge is performed in the address period.

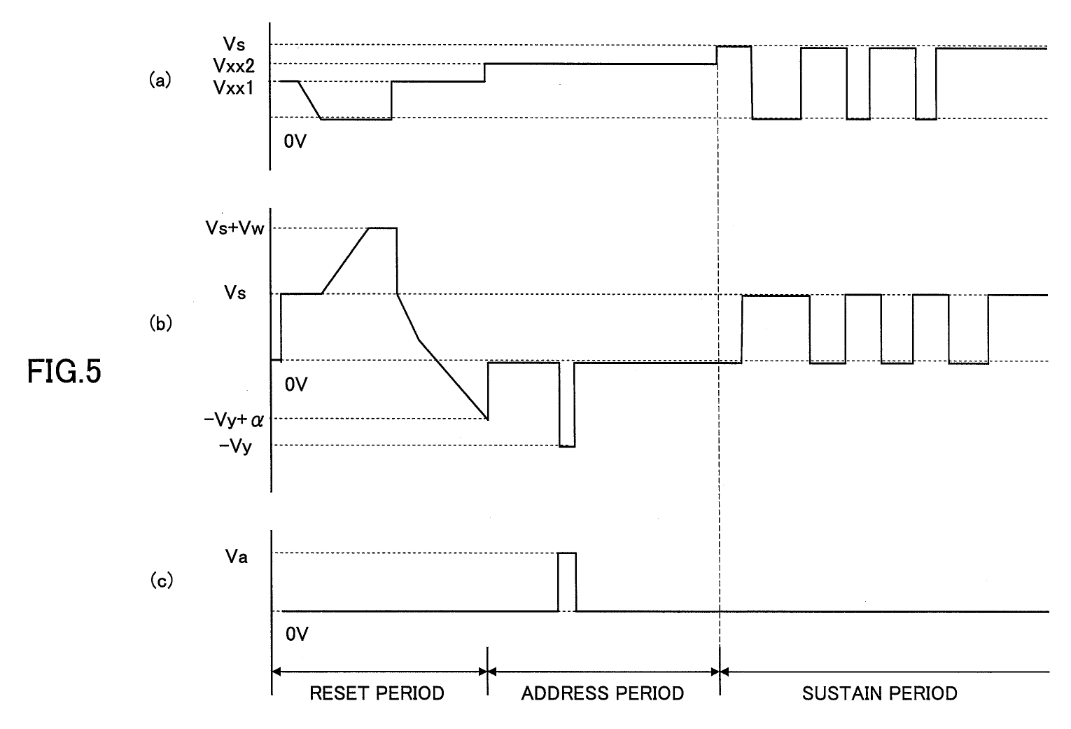

FIG. 5 is a diagram showing waveforms of voltages to be applied to corresponding electrodes in the plasma display panel driving method and the plasma display apparatus according to the embodiment of the present invention. FIG. 5(a) shows a waveform of an X sustain pulse to be applied to an X electrode Xᵢ, FIG. 5(b) shows waveforms of a Y sustain pulse and a scan pulse to be applied to a Y electrode Yᵢ, and FIG. 5(c) shows a waveform of an address pulse to be applied to an address electrode Aⱼ.

In the reset period, a voltage which is applied to an X electrode Xᵢ falls from Vxx1 to ground potential 0 V, and a voltage which is applied to a Y electrode Yᵢ rises from Vs to (Vs+Vw) ; with this, a large reset current is generated. After this, the voltage which is applied to the X electrode Xᵢ is returned to Vxx1, and a voltage which is applied to the Y electrode Yᵢ is lowered. When the voltage which is applied to the Y electrode Yᵢ becomes (−Vy+α), the voltage which is applied to the X electrode Xᵢ becomes Vxx2.

In the address period after the reset period, an address pulse Va is applied to the address electrode Aⱼ, a scan pulse −Vy is applied to the Y electrode Yᵢ, and an address discharge is generated in a discharge cell Cᵢⱼ to be lighted. In the discharge cell Cᵢⱼ to which the address pulse Va and the scan pulse −Vy are applied, the potential difference between the address electrode Aⱼ and the Y electrode Yᵢ becomes (Va−(−Vy))=(Va+Vy), and the address discharge is generated in the discharge cell Cᵢⱼ. When the address pulse Va is not applied and only the scan pulse −Vy is applied, the potential difference between the address electrode Aⱼ and the Y electrode Yᵢ is Vy, and the address discharge is not generated in the discharge cell Cᵢⱼ.

In FIG. 5, only one address pulse Va and only one scan pulse −Vy are shown; however, when one address electrode Aⱼ and plural Y electrodes Yᵢ exist, the address pulse Va and the plural scan pulses −Vy are applied to the address electrode Aⱼ and the plural Y electrodes Yᵢ, respectively.

When the address pulse Va is switched between ON and OFF with the passage of time, as shown in FIG. 5, the address pulse is pulse-shaped (a rectangular waveform with a short cycle); however, when the address pulse Va continues to be ON or OFF, the address pulse Va continues in ON, and continues 0 V in OFF. With this, the address pulse Va has a rectangular waveform with a long cycle.

Therefore, when the detected results from the address switching load detecting unit 51 and the switching load among adjacent address data 52 are used, it can be detected whether the field image is the horizontal band pattern or the zigzag pattern.

In the horizontal direction of the screen of the image, when the voltage waveform shown in FIG. 5 is formed in each address electrode Aⱼ and the number of times of the difference between ON and OFF in the address pulse among the address electrodes Aⱼ₋₁, Aⱼ, and Aⱼ₊₁ is counted at the same time, the number of times of the difference is detected in each line, each screen, or each field.

As described above, when a time change between ON and OFF of the address pulse Va and the number of adjacent ON and OFF states in a pattern in the horizontal direction are detected, the horizontal band pattern can be suitably detected.

In the sustain period shown in FIG. 5, since the sustain pulses Vs having the same voltage are alternately applied to the X electrode Xᵢ and the Y electrode Yᵢ, the sustain discharges are generated by the number of times corresponding to the weighting of the gradations.

In FIG. 5, the applied voltages are, for example, Vs=185 V, Va=75 V, Vw=180 V, −Vy=−150 V, Vxx1=130 V, Vxx2=140 V, and α=20 V. The above voltages are one example, and can be arbitrarily determined depending on application.

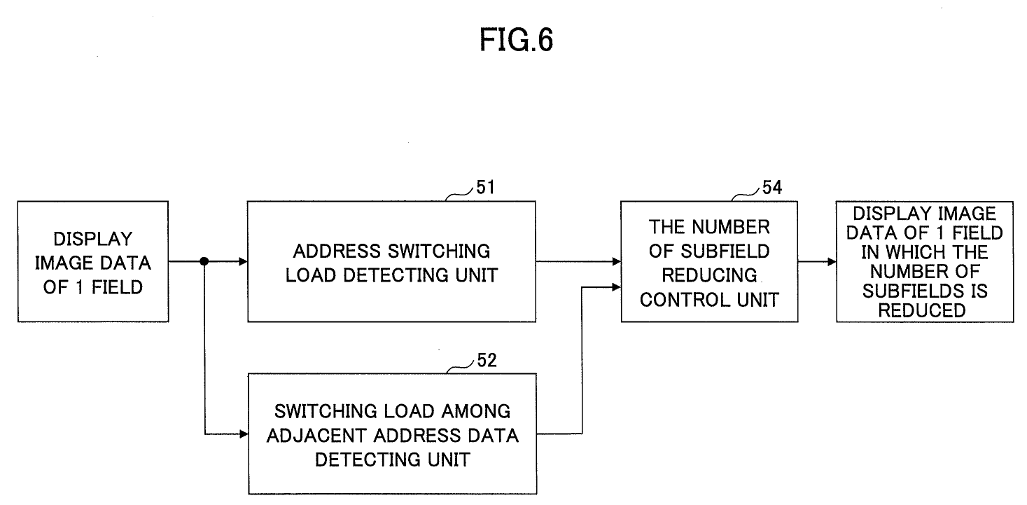

Next, referring to FIGS. 1 and 6, an example of the plasma display panel driving method and the plasma display apparatus according to the embodiment of the present invention is described in detail.

FIG. 6 is a block diagram showing the plasma display apparatus according to the embodiment of the present invention.

In FIG. 6, display image data of one field are input to the plasma display apparatus as an input signal S (see FIG. 1). The display image data of one field can be input to the control circuit 50 (see FIG. 1).

Next, from the input display image data, the address switching load detecting unit 51 detects an address switching load and the switching load among adjacent address data detecting unit 52 detects the switching load among adjacent address data (the number of times in which ON and OFF of the address pulse are differently output among the adjacent address electrodes Aⱼ₋₁, Aⱼ, and Aⱼ₊₁).

In the detection of the address switching load by the address switching load detecting unit 51, the number of switching times between ON and OFF of the address pulse Va is counted in each address electrode Aⱼ, and the counted number of switching times in all the address electrodes Aⱼ can be summed in a predetermined unit such as one field unit. With this, the total number of switching times between ON and OFF of the address pulse Va can be detected in a predetermined unit such as one screen unit, one subfield unit, and one field unit; therefore, a horizontal band pattern can be accurately detected.

In addition, in the detection of the switching load among adjacent address data by the switching load among adjacent address data detecting unit 52, the number of times in which ON and OFF of the address pulse are differently output among the adjacent address electrodes Aⱼ₋₁, Aⱼ, and Aⱼ₊₁ is detected in each line. Similar to the address switching load detecting unit 51, the detected results in all the lines are summed in the predetermined unit such as one screen unit, one subfield unit, and one field unit. With this, a pattern such as a zigzag pattern which does not generate a large amount of heat in the Y electrode driving circuit 40 can be excluded from patterns detected by the address switching load detecting unit 51; therefore, a horizontal band pattern can be accurately detected.

The number of subfield reducing control unit 54 controls reducing the number of subfields when the number of subfield reducing control unit 54 determines that display image data are formed of a horizontal band pattern or a pattern approximating the horizontal band pattern based on the detected results by the address switching load detecting unit 51 and the switching load among adjacent address data detecting unit 52. For example, the number of subfield reducing control unit 54 can control reducing the number of subfields when the display image data satisfy a predetermined condition for forming the horizontal band pattern by the detected results of the address switching load by the address switching load detecting unit 51 and the switching load among adjacent address data by the switching load among adjacent address data detecting unit 52.

When the address switching load is increased, a horizontal band pattern is likely formed; therefore, a predetermined vertical direction threshold value (first threshold value) is determined, and when the address switching load is the predetermined vertical direction threshold value or more, it is determined that a horizontal band pattern forming condition is satisfied.

The vertical direction threshold value can be determined to be, for example, a value in which a predetermined percent (%) of the maximum number of switching times between ON and OFF of the address pulse which can be obtained in one field.

For example, in a plasma display panel having 1280 pixels in the horizontal direction and 1080 pixels in the vertical direction, when the maximum number of subfields is determined to be 11 and interlaced scanning is used in which lines are scanned every two lines, the maximum value of switching times is shown in Equation (1).

The number of pixels in one field in the vertical direction in the interlaced scanning×the number of pixels in the horizontal direction×the number of subfields=the maximum value of switching times.

540×1,280×11=7,603,200 Equation (1)

For example, when the number of subfield reducing control unit 54 controls reducing one subfield every time when the number of switching times is greater than 36% of the maximum value of switching times, the vertical direction threshold value is shown in Equation (2).

The vertical direction threshold value=7,603,200×0.36=2,737,152≈2,740,000 Equation (2)

As described above, the vertical direction threshold value can be determined to be a value step by step (some percent) without determining it to be a fixed value, and the number of subfield reducing control unit 54 can control reducing one subfield every time when the number of switching times is greater than the vertical direction threshold value. With this, every time when the display pattern becomes a pattern approximating the horizontal band pattern before the display pattern becomes the horizontal band pattern, the heat generation in the Y electrode driving circuit 40 can be controlled step by step. That is, the heat generation in the Y electrode driving circuit 40 can be suitably controlled corresponding to the display pattern.

In addition, when the display pattern is a perfect horizontal band pattern, ON or OFF among the adjacent address pulses is the same in the switching load among adjacent address data (the number of times in which ON and OFF of the address pulse are differently output among the adjacent address electrodes is 0), and at this time, the maximum heat is generated in the Y electrode driving circuit 40. Therefore, since when the switching load among adjacent address data is small, the heat generation in the Y electrode driving circuit 40 is great, it can be determined that the display pattern is the horizontal band pattern or a pattern approximating the horizontal band pattern when the switching load among adjacent address data is a predetermined horizontal direction threshold value (second threshold value) or less.

The horizontal direction threshold value can be determined to be, for example, a value in which a predetermined percent (%) of the maximum number of different times between ON and OFF of the adjacent address pulses which can be obtained in one field.

As described above, for example, it is assumed that the plasma display panel has 1280 pixels in the horizontal direction, 1080 pixels in the vertical direction, the maximum number of subfields is 11, and interlaced scanning is used in which lines are scanned every two lines. In this case, when the number of subfield reducing control unit 54 controls reducing one subfield every time when the maximum number of different times between ON and OFF among the adjacent address electrodes is, for example, 2% or less, the horizontal direction threshold value is shown in Equation (3).

The horizontal direction threshold value=7,603,200×0.02=152,064≈152,000 Equation (3)

As described above, in a predetermined unit, for example, in one field unit, in a case where the address switching load is the predetermined vertical direction threshold value or more and the switching load among adjacent address data is the predetermined horizontal direction threshold value or less, the number of subfield reducing control unit 54 controls reducing the number of the subfields. When it is determined that the display pattern is the horizontal band pattern or a pattern approximating the horizontal band pattern, the heat generation in the Y electrode driving circuit 40 can be surely reduced by the number of subfield reducing control unit 54.

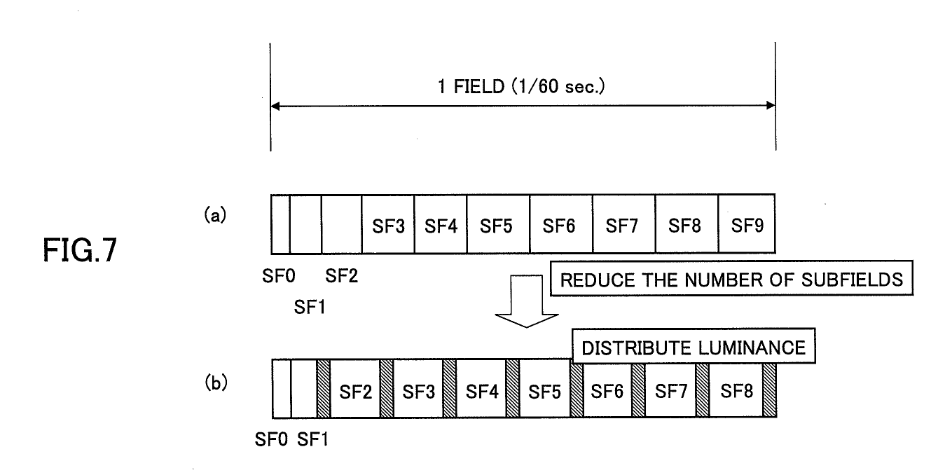

FIG. 7 is a diagram showing control of reducing the number of subfields by the number of subfield reducing control unit 54. FIG. 7(a) shows the subfields in one field before reducing the number of the subfields, and FIG. 7(b) shows the subfields in the one field after reducing the number of the subfields.

In FIG. 7(a), the one field is divided into 10 subfields SF0 through SF9. In FIG. 7(b), the number of subfields is reduced to 9; that is, the subfields SF0 through SF8 are shown. In FIG. 7(b), the subfield SF9 is reduced and luminance of the subfield SF9 is distributed to the subfields SF0 through SF8. Since the luminance of the subfield SF9 is distributed to the remaining subfields SF0 through SF8, the period of the one field is the same as that shown in FIG. 7(a), and the luminance of the one field is not decreased by distributing the luminance of the SF9 to the remaining subfields SF0 through SF8.

As described above, the number of subfield reducing control unit 54 can distribute the luminance of a reduced subfield to remaining subfields without simply reducing the number of subfields. With this, the heat generation in the Y electrode driving circuit 40 can be controlled without influencing the reduction of the number of subfields on the display image.

In FIG. 7, as an example, the highest order subfield SF9 is reduced; however, a low order subfield or a middle order subfield can be reduced depending on application.

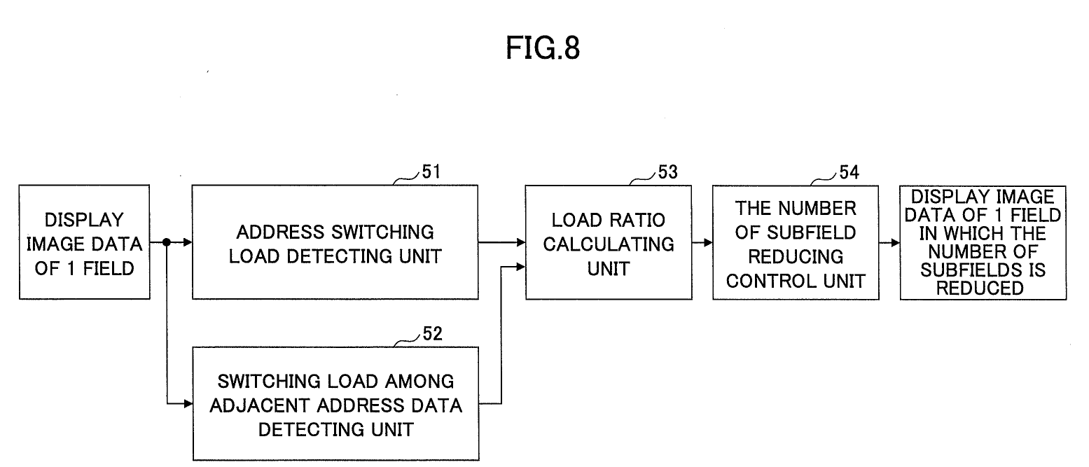

Next, referring to FIGS. 1 and 8, another example of the plasma display panel driving method and the plasma display apparatus according to the embodiment of the present invention is described in detail.

FIG. 8 is a block diagram showing the plasma display apparatus having the load ratio calculating unit 53 according to the embodiment of the present invention.

As shown in FIG. 8, when the structure shown in FIG. 8 is compared with the structure shown in FIG. 6, the plasma display apparatus shown in FIG. 8 includes the load ratio calculating unit 53. That is, display image data of one field are input to the plasma display apparatus, the address switching load detecting unit 51 detects an address switching load, the switching load among adjacent address data detecting unit 52 detects a switching load among adjacent address data, and the address switching load and the switching load among adjacent address data are input to the load ratio calculating unit 53.

That is, as shown in FIG. 8, instead of directly inputting the address switching load detected by the address switching load detecting unit 51 and the switching load among adjacent address data detected by the switching load among adjacent address data detecting unit 52 to the number of subfield reducing control unit 54, the address switching load and the switching load among adjacent address data are input to the load ratio calculating unit 53. The load ratio calculating unit 53 calculates a ratio of the address switching load (the number of switching times between ON and OFF) detected by the address switching load detecting unit 51 to the switching load among adjacent address data (the number of adjacent times of ON and OFF signals) detected by the switching load among adjacent address data detecting unit 52. Then, the number of subfield reducing control unit 54 determines that the display image data are formed of a horizontal band pattern or a pattern approximating the horizontal band pattern based on the calculated result by the load ratio calculating unit 53.

As described above, when the address switching load (the number of switching times between ON and OFF) is increased, the heat generation in the Y electrode driving circuit 40 is increased, and when the switching load among adjacent address data (the number of adjacent times of ON and OFF signals) is decreased, the heat generation in the Y electrode driving circuit 40 is increased. Therefore, the load ratio calculating unit 53 divides the switching load among adjacent address data (the number of adjacent times of ON and OFF signals) by the address switching load (the number of switching times between ON and OFF), and when the divided value is a predetermined load ratio threshold value or less, the display pattern can be determined to be the horizontal band pattern.

The load ratio threshold value can be determined to be a value obtained by, for example, dividing the horizontal direction threshold value by the vertical direction threshold value. When the load ratio obtained by dividing the switching load among adjacent address data by the address switching load is the load ratio threshold value or less, the display pattern can be determined to be the horizontal band pattern.

On the contrary, the load ratio threshold value can be determined to be a value obtained by, for example, dividing the vertical direction threshold value by the horizontal direction threshold value. When the load ratio obtained by dividing the address switching load by the switching load among adjacent address data is the load ratio threshold value or more, the display pattern can be determined to be the horizontal band pattern.

By the above structure, when the number of subfield reducing control unit 54 determines that display image data are formed of a horizontal band pattern or a pattern approximating the horizontal band pattern, the number of subfield reducing control unit 54 can determine by using only one threshold value (the load ratio threshold value) instead of using the two first and second threshold values. That is, the determining processes can be simplified.

Further, the present invention is not limited to the specifically disclosed embodiment, and variations and modifications may be made without departing from the scope of the present invention.

The present application is based on Japanese Priority Patent Application No. 2008-036381 filed on Feb. 18, 2008, with the Japanese Patent Office, the entire contents of which are hereby incorporated herein by reference.

What is claimed is:

1. A plasma display panel driving method for driving a plasma display panel by dividing one field of an image into plural subfields which plasma display panel includes plural address electrodes extending in the vertical direction, plural Y electrodes extending in the horizontal direction, and plural discharge cells formed at corresponding positions where each address electrode crosses each Y electrode in the planar view, comprising the steps of:
detecting an address switching load from input data by counting the number of switching times between ON and OFF of an address pulse applied to the address electrodes;
detecting a switching load among adjacent address data by counting the number of times in which ON and OFF of the address pulse are differently output among the adjacent address electrodes; and
controlling to reduce the number of subfields by reducing a part of the subfields when the address switching load is a predetermined first threshold value or more and the switching load among address data is a predetermined second threshold value or less.

2. The plasma display panel driving method as claimed in claim 1, wherein:
the detecting the address switching load and the detecting the switching load among adjacent address data are performed in each one field.

3. The plasma display panel driving method as claimed in claim 2, further comprising the step of:
calculating a load ratio by dividing the switching load among the adjacent address data by the address switching load, wherein:
the controlling to reduce the number of subfields is performed when the load ratio is a load ratio threshold value determined by the first threshold value and the second threshold value or less, or more.

4. The plasma display panel driving method as claimed in claim 3, wherein:
the first threshold value is determined to be 36% of the maximum switching times of the address pulse in one field.

5. The plasma display panel driving method as claimed in claim 4, wherein:
the second threshold value is determined to be 2% of the maximum switching times of the address pulse in one field.

6. The plasma display panel driving method as claimed in claim 5, wherein:
the controlling to reduce the number of subfields distributes luminance of the reduced subfield to the remaining subfields.

7. A plasma display apparatus, comprising:
a plasma display panel which includes plural address electrodes extending in the vertical direction, plural Y electrodes extending in the horizontal direction, and plural discharge cells formed at corresponding positions where each address electrode crosses each Y electrode in the planar view;
a control circuit which controls driving the plasma display panel by dividing one field of an image into plural subfields;
an address switching load detecting unit which detects an address switching load from input data by counting the number of switching times between ON and OFF of an address pulse applied to the address electrodes;
a switching load among adjacent address data detecting unit which detects a switching load among address data by counting the number of times in which ON and OFF of the address pulse are differently output among the adjacent address electrodes; and
a number of subfield reducing control unit which controls reducing a part of the subfields when the address switching load is a predetermined first threshold value or more and the switching load among address data is a predetermined second threshold value or less.

8. The plasma display apparatus as claimed in claim 7, wherein:
the address switching load detecting unit detects the address switching load and the switching load among adjacent address data detecting unit detects the switching load among adjacent address data in each one field.

9. The plasma display apparatus as claimed in claim 8, further comprising:
a load ratio calculating unit which calculates a load ratio by dividing the switching load among the adjacent address data by the address switching load, wherein
the number of subfield reducing control unit performs to control reducing the number of subfields when the load ratio is a load ratio threshold value determined by the first threshold value and the second threshold value or less, or more.

10. The plasma display apparatus as claimed in claim 9, wherein:
the first threshold value is determined to be 36% of the maximum switching times of the address pulse in one field.

11. The plasma display apparatus as claimed in claim 10, wherein:
the second threshold value is determined to be 2% of the maximum switching times of the address pulse in one field.

12. The plasma display apparatus as claimed in claim 11, wherein:
the number of subfield reducing control unit distributes luminance of the reduced subfield to the remaining subfields.
